(19) United States
(12) Patent Application Publication
(10) Pub. No.: US 2026/0088006 A1
(43) Pub. Date: Mar. 26, 2026

(54) INFORMATION PROCESSING APPARATUS, ELECTRONIC MUSICAL INSTRUMENT, CONTROL METHOD AND STORAGE MEDIUM

(71) Applicant: CASIO COMPUTER CO., LTD., Tokyo (JP)

(72) Inventor: Masaru SETOGUCHI, Tokyo (JP)

(73) Assignee: CASIO COMPUTER CO., LTD., Tokyo (JP)

(21) Appl. No.: 19/332,712

(22) Filed: Sep. 18, 2025

(30) Foreign Application Priority Data
Sep. 20, 2024 (JP) 2024-163595

(51) Int. Cl. G10H 1/00

(52) U.S. Cl. CPC G10H 1/0008; G10H 2210/036; G10H 2210/091

(57) ABSTRACT

An information processing apparatus includes at least one processor. The at least one processor searches for a silent section in a first part to be played by a user in a music piece formed of a plurality of parts. In response to the silent section being present according to the search, the at least one processor determines, from at least one part different from the first part among the plurality of parts, a second part that the user can play in the silent section. The at least one processor executes, on the determined second part, a process of allowing the user to play.

### CROSS-REFERENCE TO RELATED APPLICATIONS

This application claims the benefit of Japanese Patent Application No. 2024-163595, filed on Sep. 20, 2024, the entire disclosure of which is incorporated by reference herein.

### TECHNICAL FIELD

The present disclosure relates to an information processing apparatus, an electronic musical instrument, a control method and a storage medium.

### DESCRIPTION OF RELATED ART

There is a conventional electronic musical instrument that automatically plays a music piece including a part of the melody and parts of accompaniments. There is also an electronic musical instrument provided with a performance guidance function to help a user learn to play a part of the melody. Also, as disclosed in JP S62-36692 A, there is an electronic musical instrument capable of selecting with a user operation(s), of a music piece, a part to which the performance guidance function is applied (performance part that a user plays) and parts that are played automatically.

### SUMMARY OF THE INVENTION

One of the advantages of the present disclosure is that, in a silent section where a part that a user plays is silent in a music piece, the user can play another part.

According to an aspect of the present disclosure, there is provided an information processing apparatus including at least one processor that
searches for a silent section in a first part to be played by a user in a music piece formed of a plurality of parts,
in response to the silent section being present according to the search, determines, from at least one part different from the first part among the plurality of parts, a second part that the user can play in the silent section, and
executes, on the determined second part, a process of allowing the user to play.

### BRIEF DESCRIPTION OF DRAWINGS

FIG. 1 is a block diagram showing a functional configuration of an information processing apparatus according to an embodiment(s) of the present disclosure.

FIG. 2 schematically shows main switches included in an operation receiver.

FIG. 3 is an illustration to explain part transition in a silent section.

FIG. 4 is a flowchart of a main process that is executed by a CPU shown in FIG. 1.

FIG. 5 is a flowchart of a function process that is executed in Step S403 in FIG. 4.

FIG. 6 is a flowchart of a music piece analysis process that is executed in Step S513 in FIG. 5.

FIG. 7 is an illustration to explain a method of searching for the silent section.

FIG. 8 is a flowchart of a silent section search process that is executed in Step S601 in FIG. 6.

FIG. 9 is a flowchart of a suitable part setting process that is executed in Step S602 in FIG. 6.

FIG. 10 shows an example of transition-to-suitable-part data.

FIG. 11 is a flowchart of a music piece advancing process that is executed in Step S404 in FIG. 4.

FIG. 12 is a flowchart of a transition-to-suitable-part process that is executed in Step S1202 in FIG. 11.

### DETAILED DESCRIPTION

Hereinafter, one or more embodiments for carrying out the present disclosure will be described with reference to the drawings. Although various limitations technically preferable for carrying out the present disclosure are added to the embodiments below, the technical scope of the present disclosure is not limited to the embodiments below or illustrated examples.

First, the configuration of an information processing apparatus 1 according to an embodiment(s) of the present disclosure will be described. The information processing apparatus 1 is an apparatus that assists a user (performer) in playing on an electronic musical instrument 2 connected thereto via a musical instrument digital interface (MIDI) interface 107.

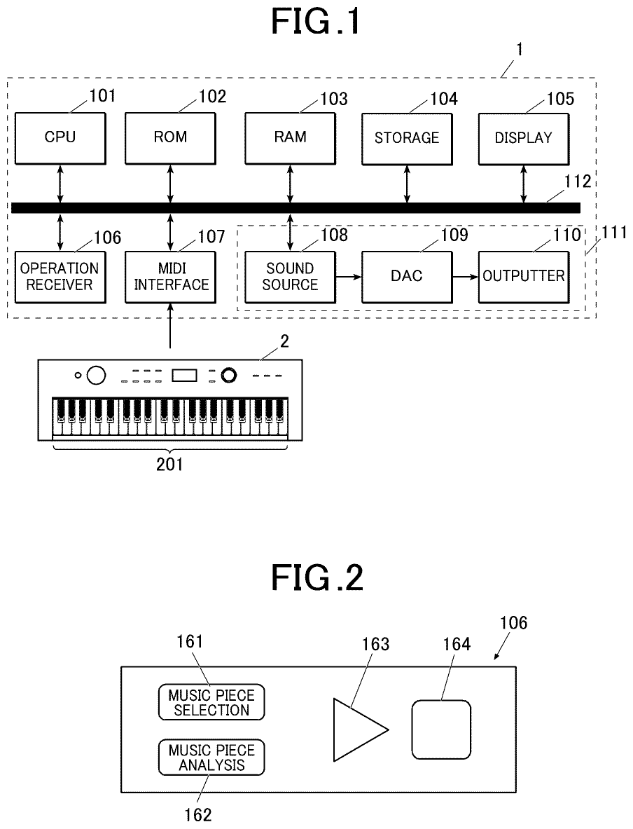

As shown in FIG. 1, the information processing apparatus 1 includes a central processing unit (CPU) 101 composed of at least one processor, a read only memory (ROM) 102, a random access memory (RAM) 103, a storage 104, a display 105, an operation receiver 106, an MIDI interface 107, which is mentioned above, a sound source 108, a digital-to-analog converter (DAC) 109 and an outputter 110. These components are connected with one another via a bus 112.

The CPU 101 is a computer that controls the components of the information processing apparatus 1 and functions as a controller. The CPU 101 reads a program specified from programs stored in the ROM 102 or the storage 104, loads the read program into the RAM 103, and executes a process among various processes in cooperation with the loaded program. The CPU 101 may be composed of a plurality of CPUs, and a plurality of processes that is executed by the CPU 101 in this embodiment may be executed by the plurality of CPUs.

The ROM 102 stores programs, various data and so forth. The RAM 103 provides the CPU 101 with a working memory space and temporarily stores data.

The storage 104 is composed of a nonvolatile semiconductor memory, such as a flash memory, a hard disk drive (HDD) and/or the like. The storage 104 stores programs, various data and so forth. The storage 104 is not limited to being built in the information processing apparatus 1, but may be or may include an external storage medium(s) attachable to and detachable from the information processing apparatus 1, such as an external HDD and/or a USB flash drive.

In this embodiment, the storage 104 stores music piece data (e.g., standard MIDI file(s) (SMF)). Each music piece data includes, for each of parts (e.g., melody part, obbligato part, electric guitar part, trumpet part, bass part, drum part, etc.) of a music piece, events, such as note-on events, note-off events and control change events, throughout the music piece from the beginning to the end thereof. The note-on events are each an event that is an instruction on sound emission and includes information on the pitch and the velocity value (intensity) at least. The note-off events are each an event that is an instruction on muting and includes information on the pitch at least. The control change events include events pertaining to control of expression added to musical sounds, such as the volume and the sound quality, and events pertaining to other control, such as master-volume change and panning.

The display 105 is composed of a liquid crystal display (LCD), an electroluminescent (EL) display or the like, and executes various types of display in accordance with display instructions from the CPU 101.

The operation receiver 106 is composed of a plurality of pushbutton switches and so forth. The operation receiver 106 detects operations on the pushbutton switches and outputs operation signals corresponding to the operations to the CPU 101. The operation receiver 106 includes a music piece selection switch 161, a music piece analysis switch 162, a music piece start switch 163 and a music piece stop switch 164 shown in FIG. 2. The music piece selection switch 161 is a switch for selecting a music piece to be played from a plurality of music piece data. The music piece analysis switch 162 is a switch for making an instruction to execute a music piece analysis process described later. The music piece start switch 163 is a switch for making an instruction to start automatic performance (playback) of a music piece. The music piece stop switch 164 is a switch for making an instruction to stop automatic performance of a music piece.

Although in this embodiment, the operation receiver 106 is composed of pushbutton switches, it may be composed of a touchscreen or the like attached to the display 105 and output operation signals corresponding to operations on the touchscreen to the CPU 101.

The MIDI interface 107 is connected with the electronic musical instrument 2 and transmits and receives data to and from the electronic musical instrument 2 in conformity with the MIDI standard.

The sound source 108 reads waveform data (audio data) stored in advance in the ROM 102 or generates waveform data and outputs the read or generated waveform data to the DAC 109 in accordance with an instruction from the CPU 101. The DAC 109 executes digital-to-analog convention on the waveform data output from the sound source 108, thereby outputting analog sounds. The outputter 110 includes an amplifier and a speaker, and amplifies and outputs the analog sounds (musical instrument sounds, etc.) input from the DAC 109. The sound source 108, the DAC 109 and the outputter 110 constitute a sound emitter 111 (sound reproducer).

The electronic musical instrument 2 is, for example, a keyboard instrument including a keyboard 201 composed of a plurality of keys (performance operation elements). Each time a key of the keyboard 201 is pressed or released, in other words, each time a performance operation is made, the electronic musical instrument 2 generates performance operation information (note-on event, note-off event, etc.) and outputs the generated performance information to the information processing apparatus 1.

Next, the operation of the information processing apparatus 1 in this embodiment will be described.

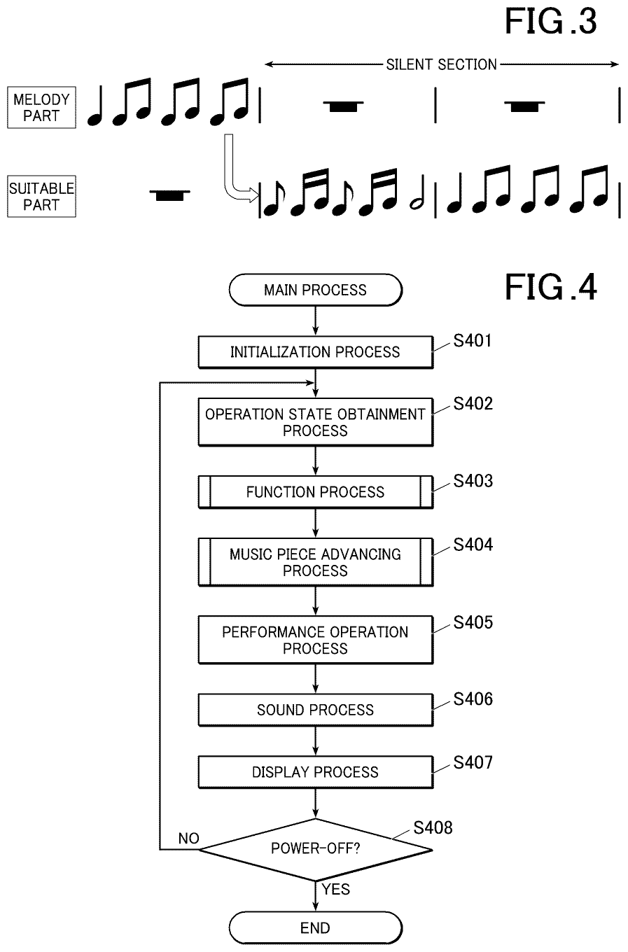

In the information processing apparatus 1 of this embodiment, a melody part (first part) that is the melody of a music piece selected by the user to play is a performance part that the user plays, and during the playback of the music piece, the melody part is not automatically played so that the user can play the melody part, whereas the other parts are automatically played on the basis of the music piece data. However, as shown in FIG. 3, in (or just before) a silent section where the melody part is silent (in a pause state), the performance part is automatically switched (transitioned) to a predetermined suitable part (second part) so that the user can play the suitable part. The suitable part is the part presumed to be most suitable among the parts except the melody part for the user to play in the silent section where the melody part to be played by the user is silent. The suitable part is determined by the music piece analysis process described later. It is preferable that the suitable part be a part in charge of solo performance, for example, in the introduction or an interlude(s).

Hereinafter, processes that are executed in the information processing apparatus 1 will be described with reference to FIG. 4 to FIG. 12. The processes shown in FIG. 4 to FIG. 12 are executed by the CPU 101 in cooperation with the programs stored in the ROM 102 or the storage 104.

When the information processing apparatus 1 is powered on, the CPU 101 starts a main process shown in FIG. 4. In the main process, first, the CPU 101 executes an initialization process (Step S401). In the initialization process, the CPU 101 initializes the components of the information processing apparatus 1 and also initializes buffers and variables that are used in various processes.

Next, the CPU 101 executes an operation state obtainment process (Step S402). In the operation state obtainment process, the CPU 101 obtains operation states of the various switches of the operation receiver 106.

Next, the CPU 101 executes a function process (Step S403). The function process is a process of executing a function in accordance with the operation states of the switches obtained by the operation state obtainment process.

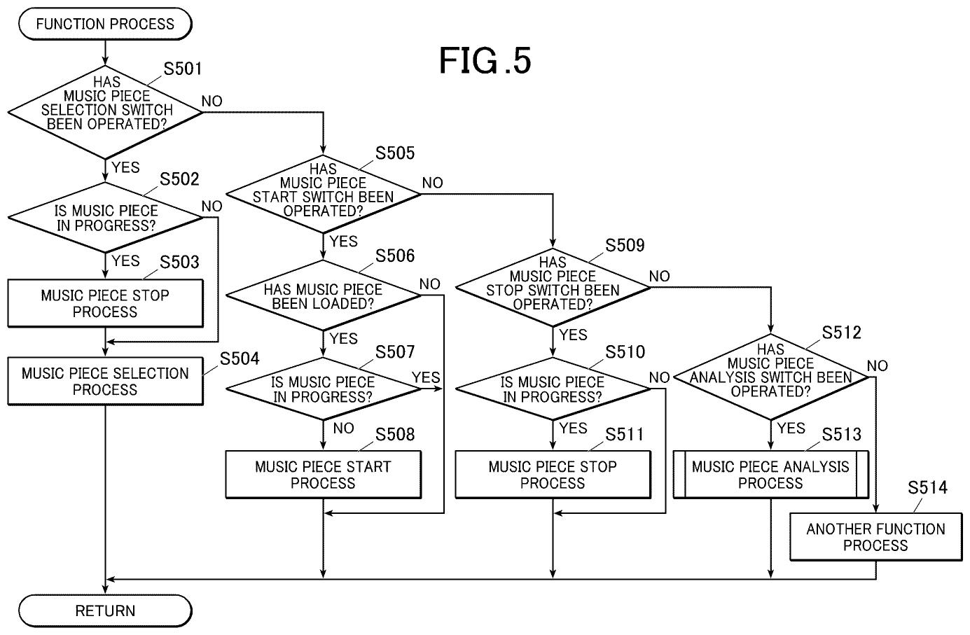

As shown in FIG. 5, in the function process, the CPU 101 first determines whether the music piece selection switch 161 has been operated (Step S501). If the CPU 101 determines that the music piece selection switch 161 has been operated (Step S501; YES), the CPU 101 determines whether a music piece is in progress (in playback) (Step S502). If the CPU 101 determines that no music piece is in progress (Step S502; NO), the CPU 101 proceeds to Step S504. If the CPU 101 determines that a music piece is in progress (Step S502; YES), the CPU 101 stops the music piece (Step S503) and proceeds to Step S504.

In Step S504, the CPU 101 executes a music piece selection process (Step S504) and proceeds to Step S404 in FIG. 4. In the music piece selection process, the CPU 101 causes the display 105 to display a list of names of selectable music pieces and waits for a user to make a music piece selection operation. When the music piece selection operation is made, the CPU 101 reads music piece data of the selected music piece from the storage 104 and loads the data into a music piece storage area of the RAM 103. At the time, if a music piece is already in the RAM 103, it is overwritten and deleted.

If the CPU 101 determines in Step S501 that the music piece selection switch 161 has not been operated (Step S501; NO), the CPU 101 determines whether the music piece start switch 163 has been operated (Step S505). If the CPU 101 determines that the music piece start switch 163 has been operated (Step S505; YES), the CPU 101 determines whether music piece data has been loaded into (and is stored in) the music piece storage area of the RAM 103 (Step S506). If the CPU 101 determines that music piece data has not been loaded into the music piece storage area of the RAM 103 (Step S506; NO), the CPU 101 proceeds to Step S404 in FIG. 4.

If the CPU 101 determines that music piece data has been loaded into the music piece storage area of the RAM 103 (Step S506; YES), the CPU 101 determines whether a music piece is in progress (Step S507). If the CPU 101 determines that a music piece is in progress (Step S507; YES), the CPU 101 proceeds to Step S404 in FIG. 4.

If the CPU 101 determines that no music piece is in progress (Step S507; NO), the CPU 101 executes a music piece start process (Step S508) and proceeds to Step S404 in FIG. 4. In the music piece start process, the CPU 101 starts automatic performance (playback) based on the music piece data loaded into the music piece storage area of the RAM 103. For example, the CPU 101 initializes variables that are used in a music piece advancing process described later to start the music piece advancing process on the basis of the music piece data loaded into the music piece storage area of the RAM 103. The CPU 101 executes the initial settings by setting “1”, “Melody Part” and “Waiting for Start of Part Transition” in “Data Index”, “Performance Part” and “State”, respectively, which are the variables that are used in the music piece advancing process.

If the CPU 101 determines in Step S505 that the music piece start switch 163 has not been operated (Step S505; NO), the CPU 101 determines whether the music piece stop switch 164 has been operated (Step S509). If the CPU 101 determines that the music piece stop switch 164 has been operated (Step S509; YES), the CPU 101 determines whether a music piece is in progress (Step S510). If the CPU 101 determines that a music piece is in progress (Step S510; YES), the CPU 101 executes a music piece stop process (Step S511), which is a process of stopping automatic performance of a music piece that is in progress, and proceeds to Step S404 in FIG. 4. If the CPU 101 determines that no music piece is in progress (Step S510; NO), the CPU 101 proceeds to Step S404 in FIG. 4.

If the CPU 101 determines in Step S509 that the music piece stop switch 164 has not been operated (Step S509; NO), the CPU 101 determines whether the music piece analysis switch 162 has been operated (Step S512). If the CPU 101 determines that the music piece analysis switch 162 has been operated (Step S512; YES), the CPU 101 executes the aforementioned music piece analysis process (Step S513) and proceeds to Step S404 in FIG. 4. The music piece analysis process will be detailed later.

If the CPU 101 determines in Step S512 that the music piece analysis switch 162 has not been operated (Step S512; NO), the CPU 101 executes another function process in accordance with an operation made on the operation receiver 106 (Step S514) and proceeds to Step S404 in FIG. 4.

In Step S404 in FIG. 4, the CPU 101 executes the aforementioned music piece advancing process (Step S404). The music piece advancing process is a process that the CPU 101 executes to advance a selected music piece (advance the playback of a selected music piece) on the basis of the music piece data of the selected music piece. The music piece advancing process will be detailed later.

Next, the CPU 101 executes a performance operation process (Step S405). In the performance operation process, the CPU 101 executes a process corresponding to a performance operation on the basis of the performance operation information input from the electronic musical instrument 2. For example, if the input performance operation information is a note-on event, the CPU 101 generates sound emission instruction information that instructs the sound emitter 111 to emit a musical sound of the pitch at the velocity value both specified in the note-on event, and outputs the generated sound emission instruction information to the sound source 108 of the sound emitter 111. As another example, if the input performance operation information is a note-off event, the CPU 101 generates mute instruction information that instructs the sound emitter 111 to mute a musical sound of the pitch specified in the note-off event, and outputs the generated mute instruction information to the sound source 108 of the sound emitter 111. As another example, if the input performance operation information is a control change event, the CPU 101 generates control information on a musical sound, and outputs the generated control information to the sound source 108 of the sound emitter 111.

Next, the CPU 101 executes a sound process (Step S406). In the sound process, the CPU 101 causes the sound emitter 111 to emit, mute or change (control) a musical sound on the basis of the sound emission instruction information, the mute instruction information or the control information output to the sound source 108 in the music piece advancing process or the performance operation process.

Next, the CPU 101 executes a display process (Step S407). In the display process, the CPU 101 causes the display 105 to display information on the progress (progression) of a music piece while the music piece is in progress. The CPU 101 causes the display 105 to display, for example, the current tempo, key, meter/beat, chord and/or the like of the music piece. The CPU 101 may cause the display 15 to display the musical score of the music piece. The CPU 101 also causes the display 105 to display the current performance part. The performance part is the part that the user plays. In this manner, the user can recognize which part he/she should play when the performance part transitions from the melody part to the suitable part.

Next, the CPU 101 determines whether a power switch included in the operation receiver 106 has been pressed (i.e., whether an instruction to power off has been made) (Step S408). If the CPU 101 determines that the power switch included in the operation receiver 106 has not been pressed (Step S408; NO), the CPU 101 returns to Step S402 to repeat Steps S402 to S408. If the CPU 101 determines that the power switch included in the operation receiver 106 has been pressed (Step S408; YES), the CPU 101 ends the main process.

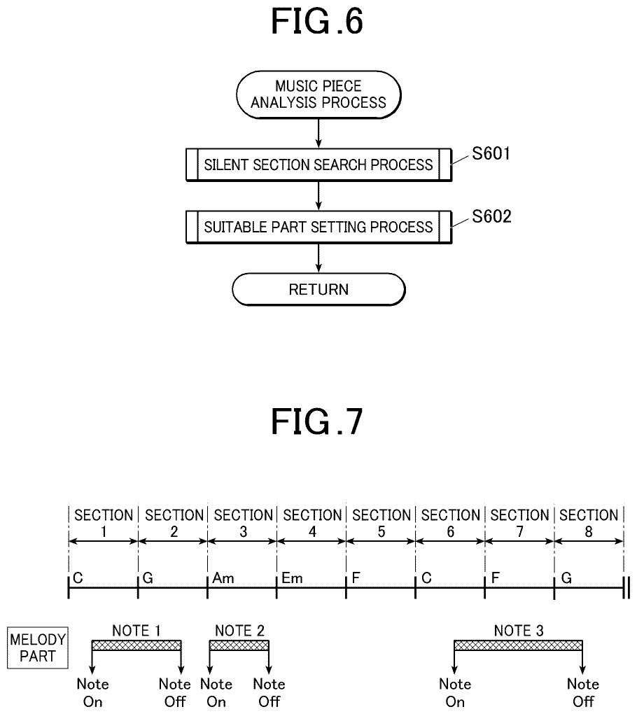

Next, the music piece analysis process that is executed in the function process will be described with reference to FIG. 6.

As shown in FIG. 6, in the music piece analysis process, the CPU 101 first executes a silent section search process of searching for the silent section in the melody part of a music piece on the basis of music piece data (Step S601).

As shown in FIG. 7, in the silent section search process of this embodiment, the CPU 101 divides a music piece into sections in units of a single chord, and searches, in the melody part, for, as the silent section, a section where neither a note-on event nor a note-off event are present and a note-on is not ongoing. In general, a music piece tends to have chord changes at points where the introduction, melody, interludes and so forth are about to start. Also, in general, phrases of a music piece themselves are units of a chord progression pattern. Therefore, it is reasonable to search for the silent section in a music piece on a single-chord-section-by-single-chord-section basis.

In this embodiment, chord information (chord events) of a music piece is embedded in music piece data in the form of character strings using markers (0xFF, 0x06) of meta events defined in SMF. For example, information on Am chord is embedded in SMF as a sequence of “0xFF, 0x06, 0x02, ‘A’, ‘m’”. The “0x02” after “0x06” indicates the number of data that follow. In FIG. 7, the single-chord sections are numbered sequentially and denoted by Section 1, Section 2, . . . , and Section 8. Shaded lines at the lower part in FIG. 7 represent notes (musical notes). They are denoted by Note 1, Note 2 and Note 3. The start of a note is a note-on event, and the note (note-on) continues until a note-off event occurs. A section where a note is ongoing is not the silent section. Therefore, if a note-on event or a note-off event is present or an ongoing note is present in a section, this section is not the silent section.

For example, in FIG. 7, Section 1 is not the silent section since the note-on event of Note 1 is present. Section 2 is not the silent section either since the note-off event of Note 1 is present. Section 3 is not the silent section either since the note-on event and the note-off event of Note 2 are present. Section 4 and Section 5 are each the silent section since neither a note-on event nor a note-off event are present and also no ongoing note is present. Section 6 is not the silent section since the note-on event of Note 3 is present. Section 7 is, although neither a note-on event nor a note-off event are present therein, not the silent section since the note-on event of Note 3 is present in the preceding Section 6 and the note is ongoing in Section 7. Section 8 is not the silent section since the note-off event of Note 3 is present.

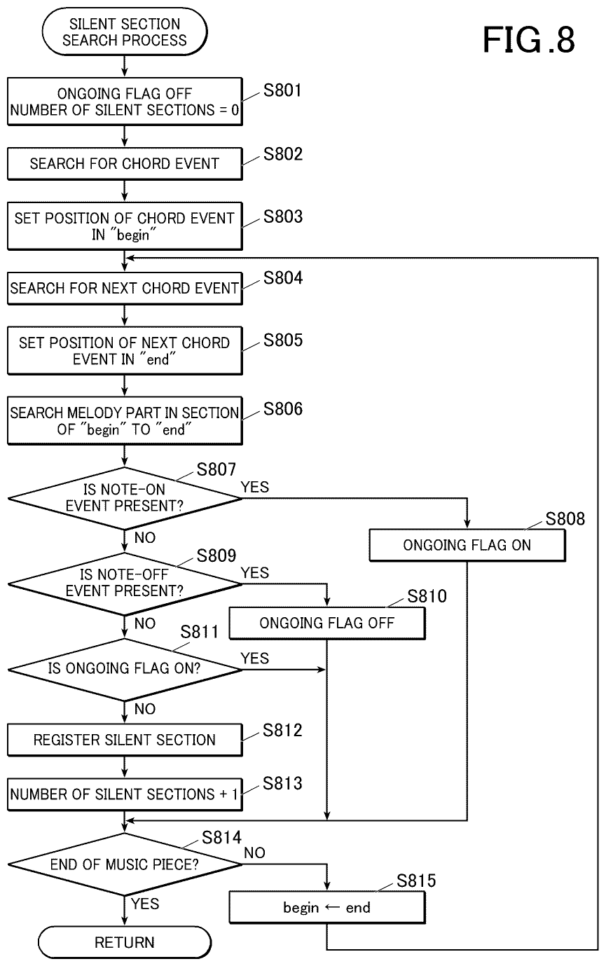

Hereinafter, the silent section search process will be described with reference to FIG. 8.

First, the CPU 101 initializes an ongoing flag indicating that a note is ongoing to OFF, and also initializes a variable in which the number of silent sections is stored to 0 (Step S801).

Next, the CPU 101 searches for a chord event in a chord track (Track 0 in this embodiment) in music piece data (SMF) (Step S802). The CPU 101 sets the time position (tick) of the retrieved chord event in a variable “begin” (Step S803). The value set in the variable “begin” at this point corresponds to the start position of Section 1 in FIG. 7.

Next, the CPU 101 searches for the next chord event (Step S804). The CPU 101 sets the time position of the retrieved chord event in a variable “end” (Step S805). The value set first in the variable “end” corresponds to the end position of Section 1 (C chord) in FIG. 7 and also corresponds to the start position of Section 2 (G chord) in FIG. 7. Therefore, the “begin” to “end” section at this point corresponds to Section 1 in FIG. 7.

Next, the CPU 101 searches for an event in the melody part in the “begin” to “end” section (Step S806) and determines whether a note-on event (“NoteOn” or “Note On”) is present in the melody part in the section (Step S807). If the CPU 101 determines that a note-on event is present in the melody part in the section (Step S807; YES), the CPU 101 sets the ongoing flag to ON (Step S808) and proceeds to Step S814.

If the CPU 101 determines that no note-on event is present in the melody part in the section (Step S807; NO), the CPU 101 determines whether a note-off event (“NoteOff” or “Note Off”) is present in the melody part in the section (Step S809). If the CPU 101 determines that a note-off event is present in the melody part in the section (Step S809; YES), the CPU 101 sets the ongoing flag to OFF (Step S810) and proceeds to Step S814.

If the CPU 101 determines that neither a note-on event nor a note-off event are present in the melody part in the section (Step S809; NO), the CPU 101 determines whether the ongoing flag is ON (Step S811). If the CPU 101 determines that the ongoing flag is ON (Step S811; YES), the CPU 101 proceeds to Step S814.

If the CPU 101 determines that the ongoing flag is not ON (Step S811; NO), the CPU 101 registers the section as the silent section in the RAM 103 (Step S812). For example, the CPU 101 registers the section as the silent section with, as a section number, a number obtained by adding one to the value of the variable in which the current number of silent sections (number thereof retrieved so far) is stored, the time position stored in the variable “begin” as the start position of the silent section, and the time position stored in the variable “end” as the end position of the silent section. Next, the CPU 101 increases the number of silent sections by one (Step S813) and proceeds to Step S814.

In Step S814, the CPU 101 determines whether the end of the music piece data has arrived (Step S814). If the CPU 101 determines that the end of the music piece data has not arrived (Step S814; NO), the CPU 101 sets the time position set in the variable “end” in the variable “begin” (Step S814) and returns to Step S804. The CPU 101 repeats Steps S804 to S815 until the end of the music piece data arrives. If the CPU 101 determines that the end of the music piece data has arrived (Step S814; YES), the CPU 101 ends the silent section search process.

Section 4 and Section 5 shown in FIG. 7 are both silent sections and contiguous. Although not shown in the flowchart of FIG. 8, such contiguous silent sections may be united into one silent section. However, if the united silent section is formed of four bars or more, it is divided, in other words, the contiguous silent sections are kept as they are. This is because only one suitable part can be set in one silent section, and accordingly even if another part that is further preferable as the suitable part is present in the middle of such a too-long silent section, the CPU 101 cannot transition the performance part to the part. Therefore, a limit is imposed on the length of one silent section.

Returning to FIG. 6, upon ending the silent section search process, the CPU 101 executes a suitable part setting process. In the suitable part setting process, the CPU 101 determines, for each silent section retrieved by the silent section search process, the suitable part suitable for the user to play in the silent section. More specifically, the CPU 101 gives the respective parts except the melody part evaluation scores in each silent section in terms of whether they are suitable for the user to play, and registers, for each silent section, the part with the highest evaluation score as the suitable part in the silent section.

In this embodiment, the parts (target parts) that the CPU 101 searches for the suitable part are an obbligato part, an electric guitar part and a trumpet part. The melody part is excluded from the list of target parts since it is the original performance part that the user plays. Further, since a bass part and a drum part are in charge of rhythm of a music piece, they are also excluded from the list of target parts in the electronic musical instrument 2 of this embodiment, which is a keyboard instrument and capable of properly outputting sounds of different pitches. However, if these parts are playable on a musical instrument interface that is connected with the information processing apparatus 1 via the MIDI interface 107, they may be included in the list of target parts. For example, if the musical instrument interface is a guitar controller, the bass part is playable and accordingly may be included in the list of target parts, whereas if the musical instrument interface is a pad controller, the drum part is playable and accordingly may be included in the list of target parts.

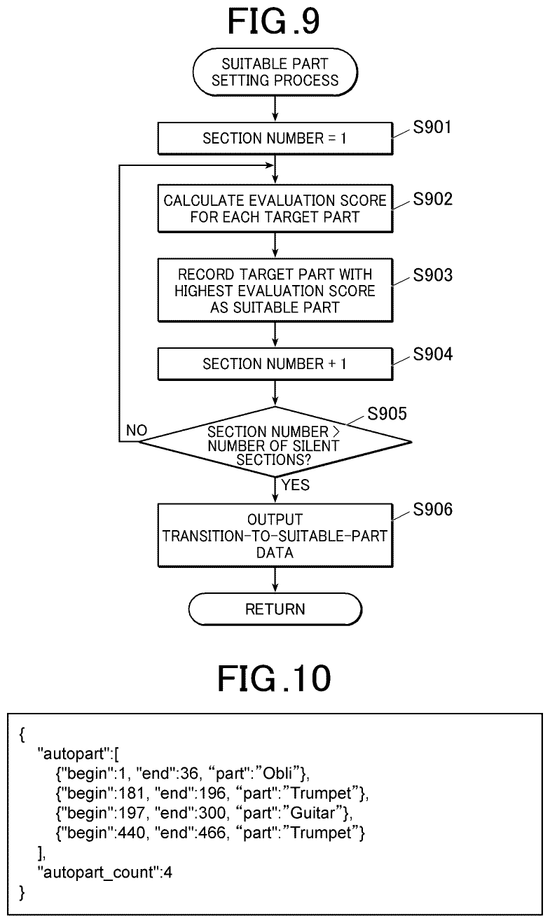

Hereinafter, the suitable part setting process will be described with reference to FIG. 9.

First, the CPU 101 sets, as the initial value, “1” in a variable in which the section number is stored (Step S901). Values of the section number are numbers assigned to the respective silent sections in order of retrieval by the silent section search process. For example, a section number of “1” indicates the first silent section in a music piece.

Next, the CPU 101 calculates evaluation scores for the respective target parts (obbligato part, electric guitar part and trumpet part) in the silent section corresponding to the current section number (Step S902).

In Step S902, the CPU 101 calculates, for each target part, the evaluation score on the basis of at least one event type of note-on events, note-off events and volume events of the target part in the silent section in the music piece data, the silent section corresponding to the current section number. For example, on the basis of note-on events, note-off events and/or volume events of each target part in the silent section, the CPU 101 obtains information on the number of overlapping notes (the number of notes of a chord that become ON (note-on) at substantially the same time), the number of notes and/or a volume value of the target part in the silent section and calculates the evaluation score for the target part. As to the number of notes, although, for example, three chords are each formed of a plurality of notes, the CPU 101 counts the notes as one note collectively.

For example, first, the CPU 101 excludes, from the list of suitable part candidates (target parts), parts with the number of overlapping notes of three or more (two is acceptable) or without a note-on for two bars or more. The reason why parts with the number of overlapping notes of three or more are excluded from the list of target parts is because in this embodiment, the melody part, which is the original performance part, is monophonic, and therefore it is preferable that the suitable part be monophonic too. The reason why the number of overlapping notes of two is acceptable is because if notes are played continuously and smoothly as in legato, the note-off of the preceding note may come after the note-on of the succeeding note. However, the number of overlapping notes of two is a target for point deduction as described below.

Next, the CPU 101 calculates the evaluation scores for the target parts as follows, the target parts not falling under the aforementioned excluded parts.
1. Deduct a point(s) if there are overlapping notes (i.e., if the number of overlapping notes is two).
2. Add more points as the volume value is higher.
3. On the basis of the number of notes in one bar of a predetermined number (eight in this embodiment) as the best, deduct more points as the number of notes in one bar is more apart (different) from the predetermined number.

The item 1 has been prepared from a point of view that as described above, parts with the number of overlapping notes of three or more are excluded from the list of target parts before evaluation scores are calculated, whereas parts with the number of overlapping notes of two are not excluded therefrom, but with the proviso that the number of overlapping notes of two, which is not monophonic, is a target for point deduction. The item 2 has been prepared from a point of view that a part having a higher volume value is closer to the foreground (is more prominent) among parts of a music piece and therefore has a higher possibility of solo performance. The item 3 has been prepared from a point of view that too many or too few notes of a part in the section make the part unsuitable for the user to play, in other words, if the number of notes is too large, it may be difficult for the user to play, whereas if the number of notes is too small, the user may become bored with playing.

For example, the CPU 101 calculates evaluation scores P for the respective target parts (which do not include the excluded parts) in the silent section by the following procedure.
(1) First, take 1.0 as the initial point/value of the evaluation score P of each target part.
(2) If the number of overlapping notes is two, multiply the evaluation score P by 0.8.
(3) Multiply the evaluation score P by a value obtained by dividing the volume value by 100. As the volume value, the value of MIDI Control Change No. 7 (main volume) is used. This value ranges from 0 to 127, and therefore if the volume value is more than 100, a point(s) are added, whereas if the volume value is less than 100, a point(s) are deducted.
(4) Execute a process of point deduction on the evaluation score P with Formula 1 below if the number of notes is not eight.

$$P = P \times ( 1. - abs ( 8. - Number of Notes ) \times 0.1 ) \qquad Formula 1$$

In Formula 1, “abs(8.0−Number of Notes)” represents the absolute value of a value obtained by subtracting the number of notes of a target part in the silent section from 8.0. In other words, as the number of notes deviates from eight, more points are deducted.

As to (4), for example, if the number of notes of a target part in the silent section is 16, the value by which the evaluation score P of the target part is multiplied is 0.2, so that point deduction occurs. As another example, if the number of notes of a target part in the silent section is one, the value by which the evaluation score P of the target part is multiplied is 0.3, so that point deduction occurs. As another example, if the number of notes of a target part in the silent section is eight, the value by which the evaluation score P of the target part is multiplied is 1.0, so that point deduction does not occur.

Returning to the flowchart of FIG. 9, the CPU 101 stores in the RAM 103 the part with the highest evaluation score P among the target parts as the suitable part for the silent section (Step S903). For example, the CPU 101 correlates and stores the current section number with the name of the part determined as the suitable part in the RAM 103.

Next, the CPU 101 increases the section number (variable) by one (Step S904) and determines whether the section number is more than the number of silent sections (Step S905). If the CPU 101 determines that the section number is not more than the number of silent sections (Step S905; NO), the CPU 101 returns to Step S902 to repeat Steps S902 to S905. If the CPU 101 determines that the section number is more than the number of silent sections (Step S905; YES), the CPU 101 generates and outputs information (transition-to-suitable-part data) for automatically transitioning the performance part to the suitable part in each silent section (Step S906) and ends the suitable part setting process.

In Step S906, for each silent section, the CPU 101 calculates, on the basis of the start position and the end position of the silent section in the music piece data, the number of beats from the beginning of the music piece to the start position at which the automatic transition to the suitable part starts in the silent section and the number of beats from the beginning of the music piece to the end position at which the automatic transition ends in the silent section. In the present disclosure, the “automatic transition ends” and similar expressions indicate that the transitioned state of the performance part to the suitable part ends. The CPU 101 then generates the transition-to-suitable-part data that includes (i) for each silent section, automatic transition data formed of the beat (start beat) at which the automatic transition to the suitable part starts, the beat (end beat) at which the automatic transition ends, and the name of the suitable part as the transition destination, and (ii) the number of automatic transition data (the number of silent sections), and outputs the generated transition-to-suitable-part data for a transition-to-suitable-part process described later. The transition-to-suitable-part data may be output in JavaScript Object Notation (JSON) format, for example. The transition-to-suitable-part data may be correlated and stored with the music piece data in the storage 104. This makes it possible to omit the music piece analysis process if a music piece about which the music piece analysis process has been executed is played back.

FIG. 10 shows an example of the transition-to-suitable-part data that is output in Step S906. The transition-to-suitable-part data is, for example, formed of two keys that are “autopart” and “autopart_count” as shown in FIG. 10. The “autopart_count” is a key that indicates how many automatic transition data for transition to the suitable part are present. In the example shown in FIG. 10, the number of the data is four. The “autopart” key is an array that includes multiple automatic transition data as array elements. Each automatic transition data is a combination of three keys and their values. The “begin” key indicates the number of beats from the beginning of a music piece to the timing at which the automatic transition starts. The “end” key indicates the number of beats from the beginning of the music piece to the timing at which the automatic transition ends. The “part” key indicates the name of the part that is the transition destination

In the example shown in FIG. 10, the transition-to-suitable-part data includes four automatic transition data. Of these four automatic transition data, according to the first automatic transition data, the transition to the obbligato part occurs from the first beat to the 36^{th} beat. It is assumed that this section is the section of the introduction of the music piece, and accordingly the melody part is silent. According to the second automatic transition data, the transition to the trumpet part occurs from the 181^{th} beat to the 196^{th} beat. According to the third automatic transition data, the transition to the guitar part occurs from the 197^{th} beat to the 300^{th} beat. It is assumed that these sections are the sections of interludes of the music piece, and accordingly the melody part is silent. According to the last automatic transition data, the transition to the trumpet part occurs from the 440^{th} beat to the 466^{th} beat. It is assumed that this section is the ending of the music piece, and accordingly the melody part is silent.

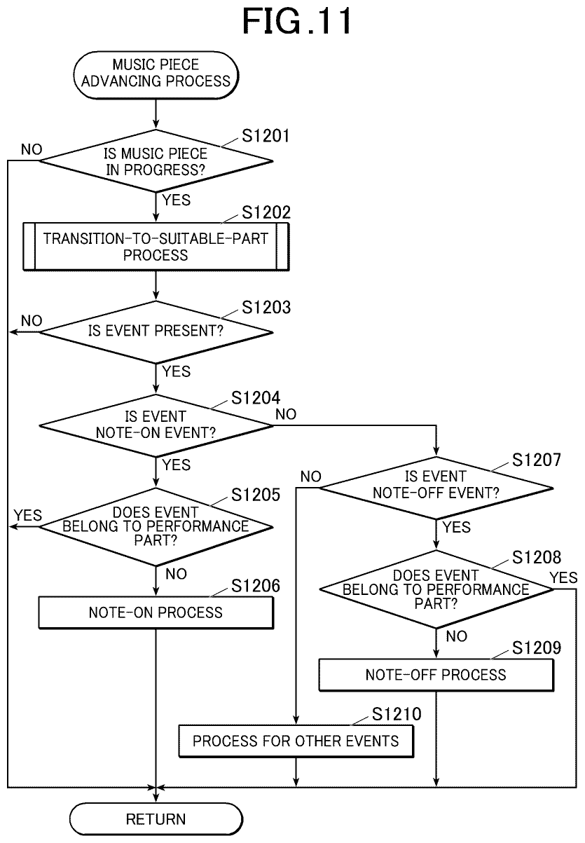

Next, the music piece advancing process, which is executed in Step S404 in FIG. 4, will be described with reference to FIG. 11. The music piece advancing process is a process of advancing the playback of a music piece in accordance with the progression of time. The music piece advancing process includes the aforementioned transition-to-suitable-part process of switching the performance part on the basis of the generated transition-to-suitable-part data.

In the music piece advancing process, the CPU 101 first determines whether a music piece is in progress by automatic performance (Step S1201). If the CPU 101 determines that no music piece is in progress by automatic performance (Step S1201; NO), the CPU 101 exits the music piece advancing process and proceeds to Step S405 in FIG. 4. If the CPU 101 determines that a music piece is in progress by automatic performance (Step S1201; YES), the CPU 101 executes the transition-to-suitable-part process (Step S1202).

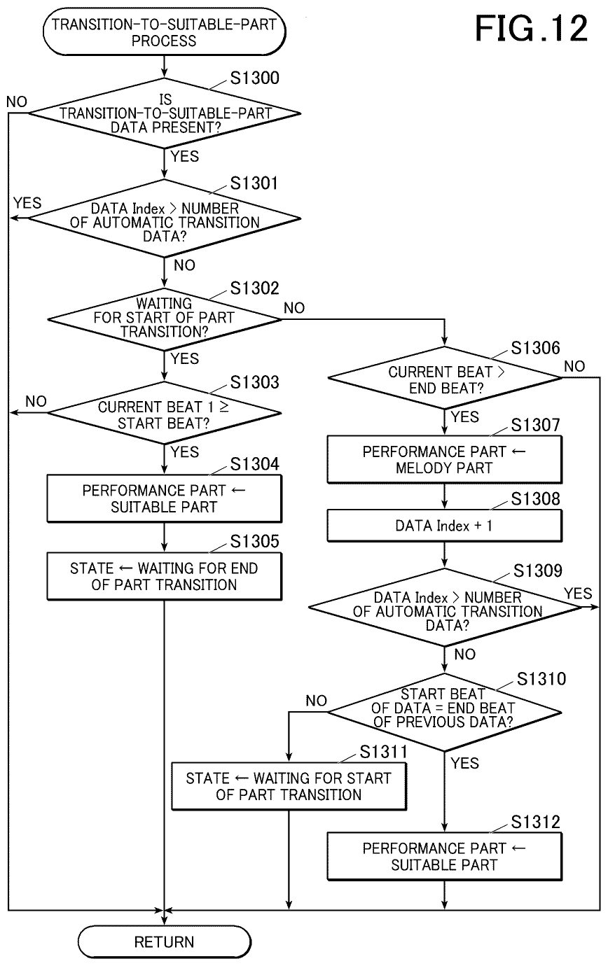

Hereinafter, the transition-to-suitable-part process will be described with reference to FIG. 12. The CPU 101 first determines whether the transition-to-suitable-part data of the music piece in progress is present (Step S1300). If the CPU 101 determines that the transition-to-suitable-part data of the music piece in progress is not present (Step S1300; NO), the CPU 101 exits the transition-to-suitable-part process and proceeds to Step S1203 in FIG. 11.

If the CPU 101 determines that the transition-to-suitable-part data of the music piece in progress is present (Step S1300; YES), the CPU 101 determines whether the data Index is more than the number of automatic transition data described above (Step S1301). The data Index indicates a number of (assigned to, in order from the top) automatic transition data that the CPU 101 refers to, and “1” is set as the initial value. If the CPU 101 determines that the data Index is more than the number of automatic transition data (Step S1301; YES), the CPU 101 exits the transition-to-suitable-part process and proceeds to Step S1203 in FIG. 11. The data Index being more than the number of automatic transition data means that all the transitions to the suitable part in the music piece in progress have ended, and accordingly the CPU 101 exits the transition-to-suitable-part process.

If the CPU 101 determines that the data Index is not more than the number of automatic transition data (Step S1301; NO), the CPU 101 determines whether it is in a part transition start waiting state (Step S1302). The part transition start waiting state is a state of waiting for the timing at which the performance part transitions from the melody part to the suitable part described in the automatic transition data. Whether the CPU 101 is in the part transition start waiting state can be determined from the value of the variable “State”, in which the state of the CPU 101 (information processing apparatus 1) is stored.

If the CPU 101 determines that it is in the part transition start waiting state (Step S1302; YES), the CPU 101 determines whether the current beat in the music piece is equal to or over the start beat described in the automatic transition data (Step S1303). If the CPU 101 determines that the current beat is not equal to or over the start beat described in the automatic transition data (Step S1303; NO), the CPU 101 exits the transition-to-suitable-part process and proceeds to Step S1203 in FIG. 11.

If the CPU 101 determines that the current beat is equal to or over the start beat described in the automatic transition data (Step S1303; YES), the CPU 101 transitions the performance part to the suitable part described in the automatic transition data (Step S1304). As described later, in the music piece advancing process, the part specified as the performance part is controlled not to be played by automatic performance, in other words, not to be played back. Therefore, the user himself/herself can play the suitable part set as the performance part.

Next, the CPU 101 sets a part transition end waiting state in the variable “State” (Step S1305) and proceeds to Step S1203 in FIG. 11. The part transition end waiting state is a state of waiting for the timing at which the transition to the suitable part ends and the performance part returns to the melody part, which is the normal performance part.

If the CPU 101 determines in Step S1302 that the current state is not the part transition start waiting state, in other words, is the part transition end waiting state (Step S1302; NO), the CPU 101 determines whether the current beat in the music piece is over the end beat of the automatic transition data (Step S1306). If the CPU 101 determines that the current beat is not over the end beat of the automatic transition data (Step S1306; NO), the CPU 101 exits the transition-to-suitable-part process and proceeds to Step S1203 in FIG. 11.

If the CPU 101 determines that the current beat is over the end beat of the automatic transition data (Step S1306; YES), the CPU 101 returns, namely transitions, the performance part to the melody part (Step S1307).

Next, the CPU 101 increases the data Index by one (Step S1308) and determines whether the value of the data Index is more than the number of automatic transition data (Step S1309). If the CPU 101 determines that the value of the data Index is more than the number of automatic transition data (Step S1309; YES), the CPU 101 proceeds to Step S1203 in FIG. 11.

If the CPU 101 determines that the value of the data Index is equal to or less than the number of automatic transition data (Step S1309; NO), the CPU 101 determines whether the start beat of the automatic transition data is equal to the end beat of the previous (immediately preceding) automatic transition data (Step S1310). The start beat of the automatic transition data being equal to the end beat of the previous automatic transition data means that silent sections are contiguous.

If the CPU 101 determines that the start beat of the automatic transition data is equal to the end beat of the previous automatic transition data (Step S1310; YES), the CPU 101 transitions the performance part to the suitable part described in the automatic transition data (Step S1312) and proceeds to Step S1203 in FIG. 11.

If the CPU 101 determines that the start beat of the automatic transition data is not equal to the end beat of the previous automatic transition data (Step S1310; NO), the CPU 101 sets the part transition start waiting state in the variable “State” (Step S1311) and proceeds to Step S1203 in FIG. 11.

In Step S1203 in FIG. 11, the CPU 101 determines whether any event to be processed at this point is present in the music piece data (Step S1203). If the CPU 101 determines that no event to be processed at this point is present in the music piece data (Step S1203; NO), the CPU 101 exits the music piece advancing process and proceeds to Step S405 in FIG. 4.

If the CPU 101 determines that an event to be processed at this point is present in the music piece data (Step S1203; YES), the CPU 101 determines whether the event is a note-on event (Step S1204). If the CPU 101 determines that the event is a note-on event (Step S1204; YES), the CPU 101 determines whether the note-on event is a note-on event belonging to the performance part (Step S1205). If the CPU 101 determines that the note-on event is a note-on event belonging to the performance part (Step S1205; YES), the CPU 101 exits the music piece advancing process and proceeds to Step S405 in FIG. 4. Since the performance part is the part that the user plays, automatic performance (playback process) thereof is not executed in this embodiment. In other words, on the note-on event belonging to the performance part, the CPU 101 executes a no-sound process of executing control not to execute a note-on process of generating the sound emission instruction information, thereby executing control not to execute the playback of the performance part, in other words, executing a no-playback process on the performance part.

If the CPU 101 determines that the note-on event is not a note-on event belonging to the performance part (Step S1205; NO), the CPU 101 executes the note-on process (Step S1206) and proceeds to Step S405 in FIG. 4. In the note-on process, the CPU 101 generates the sound emission instruction information to cause the sound emitter 111 to emit a musical sound corresponding to the note-on event, and outputs the generated sound emission instruction information to the sound source 108.

If the CPU 101 determines in Step S1204 that the event is not a note-on event (Step S1204; NO), the CPU 101 determines whether the event is a note-off event (Step S1207). If the CPU 101 determines that the event is a note-off event (Step S1207; YES), the CPU 101 determines whether the note-off event is a note-off event belonging to the performance part (Step S1208). If the CPU 101 determines that the note-off event is a note-off event belonging to the performance part (Step S1208; YES), the CPU 101 exits the music piece advancing process and proceeds to Step S405 in FIG. 4. Since the performance part is the part that the user plays, automatic performance thereof is not executed in this embodiment.

If the CPU 101 determines that the note-off event is not a note-off event belonging to the performance part (Step S1208; NO), the CPU 101 executes a note-off process (Step S1209) and proceeds to Step S405 in FIG. 4. In the note-off process, the CPU 101 generates the mute instruction information to cause the sound emitter 111 to mute a musical sound corresponding to the note-off event, and outputs the generated mute instruction information to the sound source 108.

If the CPU 101 determines in Step S1207 that the event is not a note-off event (Step S1207; NO), the CPU 101 executes a process for other events (Step S1210) and proceeds to Step S405 in FIG. 4.

Events that are processed by the process for other events are ornamental events to control the volume and the pitch of the musical sound being emitted, such as expression and pitch bend of control change events. In this embodiment, on the other events, which are neither note-on events, which emit musical sounds directly, nor note-off events, which mute musical sounds directly, processes corresponding to their respective events are executed regardless of whether they belong to the performance part. For example, a sound being emitted by a user's performance operation is ornamented on the basis of the music piece data, for example, by the volume being changed by an expression event or by the pitch being changed by a pitch bend event, the events being included in the music piece data. The other events, which are neither note-on events nor note-off events, belonging to the performance part may not be processed in the same/similar manner as/to note-on events or note-off events. For example, pitch bend data included in the music piece data may be discarded, and the user may operate a pitch bender provided in the electronic musical instrument 2 to put the pitch bend effect on musical sounds.

As described above, the transition-to-suitable-part process in the music piece advancing process realizes, when the melody part is silent, the transition of the performance part to the suitable part determined by the suitable part setting process.

In this embodiment, the CPU 101 allows the user to play the performance part by not causing the electronic musical instrument 2 to execute automatic performance of the performance part. At the time, the CPU 101 may cause, among LEDs (of an optical keyboard, for example) embedded in the performance operation elements of the electronic musical instrument 2 or LEDs installed near the performance operation elements, LEDs corresponding to the pitches of notes to be played to light up at their respective performance timings to guide the user in playing. The performance guidance can also be realized by an application on a smartphone or a tablet provided with a display device. Further, the performance part may be played by, what is called, any key performance, which emits sounds at correct pitches regardless of pitches specified by the performance operation elements. In this way, even if the user is a beginner in musical instruments and insecure about specifying pitches, he/she can play a music piece at correct pitches and enjoy playing throughout the music piece, which includes the introduction, interludes and ending.

According to the conventional techniques, in the silent section where the performance part is silent in a music piece, the user has no choice but to listen to automatic performance of the parts other than the performance part, without playing. In contrast, the CPU 101 of the information processing apparatus 1 searches, in a music piece formed of a plurality of parts, for the silent section where the melody part to be played by the user is silent, and determines the suitable part presumed to be most suitable for the user to play in the silent section among the plurality of parts except the melody part. When the silent section arrives while the music piece is in progress, the CPU 101 transitions the performance part from the melody part to the suitable part as a part playable by the user, and when the silent section ends, the CPU 101 transitions the performance part from the suitable part to the melody part. Thus, by playing another part of the music piece in the silent section where the part to be played by the user is silent, the user can get more opportunities to play and enjoy playing more.

Further, the CPU 101 divides the music piece into sections in units of a single chord, and searches, in the melody part, for the silent section where neither a note-on event nor a note-off event are present and a note-on is not ongoing. Thus, it is possible to properly search for the silent section in the music piece on the single-chord-section-by-single-chord-section basis.

Further, the CPU 101 determines the suitable part on the basis of at least one of the number of overlapping notes, the number of notes and the volume value of each of the plurality of parts except the melody part in the silent section. Thus, it is possible to appropriately determine the suitable part that the user plays in the silent section on the basis of at least one of the number of overlapping notes, the number of notes and the volume value.

Further, the CPU 101 calculates the evaluation value (evaluation score) for, as a part that the user plays in the silent section, each of the plurality of parts except the melody part on the basis of the number of overlapping notes, the number of notes and the volume value of each of the plurality of parts except the melody part in the silent section, and determines the part with the highest evaluation value as the suitable part. Thus, it is possible to determine, as the suitable part, the part having received the highest evaluation as the part that the user plays in the silent section.

Further, the evaluation value is higher as the number of overlapping notes is smaller, the number of notes is closer to a predetermined number, and the volume value is higher. This makes it possible to determine, as the suitable part, the part that is monophonic, has an appropriate number of notes, and is prominent with a high volume, and allows the user to play the suitable part thus determined.

Further, when the silent section ends while the music piece is in progress, the CPU 101 transitions the performance part that the user plays to the suitable part determined for the next silent section if the silent section and the next silent section are contiguous. Thus, even if silent sections are contiguous, it is possible to transition the performance part to the suitable part determined for each silent section.

Further, the CPU 101 executes control not to execute the playback of the part that the user plays while the music piece is in progress. This can prevent reproduced sounds from interfering with the user's performance.

Those described in the above embodiment are not limitations but some preferable examples of the information processing apparatus, the electronic musical instrument, the control method and the storage medium according to the present disclosure.

For example, although in the above embodiment, the information processing apparatus 1 and the electronic musical instrument 2 are separate units, the functions disclosed herein that are executed by the CPU 101 of the information processing apparatus 1 and a sound emitter corresponding to the sound emitter 111 may be provided in the electronic musical instrument 2.

Further, although in the above embodiment, the melody part is the first part, the first part is not limited thereto.

Further, although in the above embodiment, a music piece is divided by chord, and the CPU 101 searches for a single-chord section(s) where neither a note-on event nor a note-off event are present and a note-on is not ongoing as the silent section, the method of searching for the silent section is not limited thereto. For example, regardless of chord, the CPU 101 may search for a section where a note-on is not present for a predetermined period or longer as the silent section.

Further, although in the above embodiment, the electronic musical instrument 2 is a keyboard instrument, the electronic musical instrument of the present disclosure may be another electronic musical instrument, such as a wind synthesizer, an electric guitar or an MIDI violin.

Further, although in the above embodiment, the computer-readable storage medium storing the programs of the present disclosure is a semiconductor memory, such as a ROM or a hard disk, the computer-readable storage medium is not limited thereto. As the computer-readable storage medium, a portable storage medium, such as a CD-ROM, can be used appropriately. Further, a carrier wave can also be used appropriately as a storage medium that provides data of the programs of the present disclosure via a communication line.

Further, the detailed configuration and detailed operation of the information processing apparatus 1 can be changed as appropriate without departing from the scope of the present disclosure.

Although one or more embodiments of the present disclosure have been described above, the technical scope of the present disclosure is not limited to the embodiments described above but defined on the basis of claims. The technical scope of the present disclosure includes not only the scope of claims but also the scope of claims with changes unrelated to the essence of the present disclosure added.

1. An information processing apparatus comprising at least one processor that
searches for a silent section in a first part to be played by a user in a music piece formed of a plurality of parts,
in response to the silent section being present according to the search, determines, from at least one part different from the first part among the plurality of parts, a second part that the user can play in the silent section, and
executes, on the determined second part, a process of allowing the user to play.

2. The information processing apparatus according to claim 1, wherein the at least one processor divides the music piece into sections in units of a single chord, and searches for, in the first part, a section where neither a note-on event nor a note-off event are present and a note-on is not ongoing as the silent section.

3. The information processing apparatus according to claim 1, wherein the at least one processor determines the second part based on at least one of a number of overlapping notes, a number of notes or a volume value of each of the at least one part, which is different from the first part, in the silent section.

4. The information processing apparatus according to claim 1, wherein at an end of the silent section, the at least one processor executes, on the second part, control to cancel the process of allowing the user to play.

5. The information processing apparatus according to claim 1, wherein in response to the silent section being contiguous with a next silent section in the music piece, the at least one processor executes, on a second part determined for the next silent section, the process of allowing the user to play.

6. The information processing apparatus according to claim 1, wherein the at least one processor executes a playback process on the second part of the music piece in a section different from the silent section, and executes a no-playback process on the second part of the music piece in the silent section as the process of allowing the user to play.

7. An electronic musical instrument comprising:
the information processing apparatus according to claim 1; and
a performance operation element with which the user makes a performance operation.

8. A control method that is performed by a computer, comprising:
searching for a silent section in a first part to be played by a user in a music piece formed of a plurality of parts;
in response to the silent section being present according to the search, determining, from at least one part different from the first part among the plurality of parts, a second part that the user can play in the silent section; and
executing, on the determined second part, a process of allowing the user to play.

9. The control method according to claim 8, wherein the searching includes dividing the music piece into sections in units of a single chord, and searching for, in the first part, a section where neither a note-on event nor a note-off event are present and a note-on is not ongoing as the silent section.

10. The control method according to claim 8, wherein the determining includes determining the second part based on at least one of a number of overlapping notes, a number of notes or a volume value of each of the at least one part, which is different from the first part, in the silent section.

11. The control method according to claim 8, further comprising, at an end of the silent section, executing, on the second part, control to cancel the process of allowing the user to play.

12. The control method according to claim 8, wherein the executing includes, in response to the silent section being contiguous with a next silent section in the music piece, executing, on a second part determined for the next silent section, the process of allowing the user to play.

13. The control method according to claim 8, further comprising executing a playback process on the second part of the music piece in a section different from the silent section,
wherein the executing of the process of allowing the user to play includes executing a no-playback process on the second part of the music piece in the silent section as the process of allowing the user to play.

14. A non-transitory computer-readable storage medium storing a program causing a computer to:
search for a silent section in a first part to be played by a user in a music piece formed of a plurality of parts;
in response to the silent section being present according to the search, determine, from at least one part different from the first part among the plurality of parts, a second part that the user can play in the silent section; and
execute, on the determined second part, a process of allowing the user to play.
